(19) United States
(12) Patent Application Publication
(10) Pub. No.: US 2024/0290989 A1
(43) Pub. Date: Aug. 29, 2024

(54) An Improved Battery Grid and Electrode Thereof Vehicle

(71) Applicant: ATOA Scientific Technologies Pvt. Ltd, Bangalore (IN)

(72) Inventor: Raj CN Thiagarajan, Bangalore (IN)

(73) Assignee: ATOA Scientific Technologies Pvt. Ltd, Bangalore (IN)

(21) Appl. No.: 18/571,612

(22) PCT Filed: Jul. 14, 2022
(86) PCT No.: PCT/IB2022/056481

§ 371 Date: Dec. 18, 2023

(30) Foreign Application Priority Data
Jul. 17, 2021 (IN) 202041030761

(51) Int. Cl. H01M 4/66; H01M 4/68; H01M 4/73

(52) U.S. Cl. CPC H01M 4/667; H01M 4/685; H01M 4/73

(57) ABSTRACT

The present disclosure provides a multi-physics engineered multi-material electrode grid plate for improved performance of a battery having uniform current collection and transport. The grid comprises a plurality of vertical grid wires (102, 406), a plurality of horizontal grid wires (104, 404), a plurality of frame grid wires, wherein the vertical grid wires (102, 406) and the horizontal grid wires (104, 404) provided between the frame grid wires for current transport. An active material current collector (108, 408) is provided for current collection and an active material utilization enhancer (601) is configured in a lateral cross-section of the grid wires ((102, 406) (104, 404)) with maximum surface perimeter.

### FIELD

The embodiments herein generally relate to electrodes in a battery. More particularly, the disclosure relates to an electrode in a battery grid for improving battery performance.

### BACKGROUND AND PRIOR ART

The ability to chemically store energy in a battery has transformed the way we power our world. Among the chemical storage batteries, Lead acid battery is the workhorse of the industry. Lead acid batteries are 160+year old technology. However, Lead acid battery demand is ever increasing in starter, energy storage, electrical vehicles, due to its reliability, availability, recyclability and low cost.

Advantages of Lead acid battery include low cost, established technological process, extensive industrial manufacturing capacity availability, long operation in variable charge conditions and effective recyclability. The main disadvantages include higher weight, lower energy density, poor high-rate discharge performance, and lower cycle life.

The critical component in lead acid battery is the grid plate (both negative and positive). Battery grid plates are composed of lead alloy current collector and active mass (negative or positive) pasted on the grid. A main function of the grid is to hold the active-material mass (negative or positive) within the grid network, transport the discharge current out of the active-material and the recharge current back into the active-material. However, the grid must utilize the active mass efficiently. Moreover, the grid must have sufficient stiffness and strength to hold the active-material to withstand forces generated during charging, discharging and operational loads. Also, sizes of high current density in the grid corresponded to sizes of high corrosion and reduce service life. better active mass utilization, uniform current density, lower grid resistance, improved resistance to thermal, structural and live loads and lower weight. Further, the grid design influences the Lead acid batteries, Capacity, weight, Energy density, high-rate discharge performance, service life and sustainability. Grid plates needs to perform at its maximum chemical, electrical, thermal, structural, service life capacity for maximum performance of the Lead acid batteries.

Therefore, there is a need for a battery grid and an improved electrode with reduced weight providing uniform current transport, maximum active material utilization, low ohmic resistance, for improved capacity, specific Energy density, high-rate discharge performance and service life of lead acid battery. Moreover, there is a need for an improved battery grid and electrodes thereof for efficient on-demand energy storage of Lead acid batteries.

### OBJECTS

Some of the objects of the present disclosure are described herein below:

The main objective of the present disclosure is to provide a battery grid and an electrode thereof for improving overall battery performance.

Another objective of the present disclosure is to provide a battery grid and an electrode thereof for improving uniform current collection, uniform current transport, maximizing active material utilization, having low ohmic resistance and light in weight.

Still another objective of the present disclosure is to provide a durable multi-material battery grid for improved capacity, specific energy density, light weight, high-rate discharge performance and service life of a battery.

Yet another objective of the present disclosure is to provide a multi-material battery grid that is multi-physics optimized and performs at maximum of chemical, electrical, thermal, structural, service life capacity.

Still another objective of the present disclosure is to provide a multi-material battery grid that maximizes the performance of the battery.

Yet another objective of the present disclosure is to provide a multi-material battery grid that reduces the weight of the battery.

Still another objective of the present disclosure is to provide a multi-material battery grid that improves the service life of the battery.

Yet another objective of the present disclosure is to provide a multi-material battery grid that uses the existing manufacturing capacity and battery configuration (other than grid) to improve battery performance.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides an improved battery grid and an electrode thereof.

In accordance with an embodiment, the grid comprises of a plurality of vertical grid wires, a plurality of horizontal grid wires, a plurality of frame grid wires including a top frame grid wire, a bottom frame grid, a left frame grid wire and a right frame grid wire. The vertical grid wires and the horizontal grid wires are provided between the frame grid wires for current transport, and an active material current collector is provided for current collection. An active material utilization enhancer is configured in a lateral cross-section of the grid wires with maximum surface perimeter.

In accordance with an embodiment, the lateral cross-section of the grid wires including at least one of a primary current collector and transporter, a corrosion resistant coating, a secondary current collection enhancer and transporter and an air core.

In an embodiment, the secondary current collection enhancer and transporter is provided in an axially inner portion, the corrosion resistant coating surrounds the secondary current collection enhancer and transporter and the primary current collector and transporter surrounds corrosion resistant coating. In an embodiment, an air core provided at a center of the lateral cross-section of vertical grid wire for reducing weight of the grid. In an embodiment, a material of the primary current collector and transporter includes lead and lead alloys. In an embodiment, a material of the corrosion resistant coating of conductive composite and materials exhibiting electrical conducting property and corrosion resistance including Polyaniline. In an embodiment, a material of the secondary current collection enhancer and transporter including material with specific conductivity higher than lead and lead alloys.

In accordance with another embodiment, the grid includes a planar spatial configuration, wherein sizes of corner active material current collectors nearer to a lug are greater than sizes of corner active material current collectors away from the lug for maximizing uniform current collection and transport.

In accordance with another embodiment, the grid includes a planar spinal configuration including a spine provided at a location corresponding to a location of a lug. Size of the spine is greater than size of frame grid wires and lesser than size of the horizontal grid wires and the vertical grid wires for allowing faster current flow. In an embodiment, sizes of active material current collectors other than the active material current collectors are in linear spatial progression from the corner active material current collector nearer to the lug to the corner active material current collector away from the lug.

In accordance with an embodiment, the vertical grid wires include a top current collector nearer to the top frame grid wire and a bottom current collector nearer to the bottom frame grid wire and a size of the top current collector is greater than a size of the bottom current collector.

In accordance with an embodiment, the active material utilization enhancer is configured in a shape of a Koch fractal curve with maximum surface perimeter for a given area of the active material current collector, thereby maximizing battery capacity, improving uniform current density, decreasing corrosion and increasing service life

In accordance with an embodiment, the battery is selected from a group consisting of lead acid battery, bipolar lead acid battery, primary disposable batteries, zinc carbon battery, zinc chloride battery, lithium battery, silver battery, mercury oxide and zinc air battery, secondary rechargeable batteries, nickel cadmium battery, nickel metal hydride battery, alkaline battery, lithium ion battery, lithium ion polymer battery and batteries used in residential, industrial, transportation, consumer, electronic, medical, military and space applications.

In accordance with an embodiment, a grid for a battery configured for uniform current collection and transport, comprises an electrochemically active material space formed between vertical grid wires and horizontal grid wires wherein sizes of corner active material current collectors nearer to a lug greater than sizes of corner active material current collectors away from the lug and sizes of active material current collectors other than the active material current collectors are in linear spatial progression from the corner active material current collector nearer to the lug to the corner active material current collector away from the lug.

In accordance with another embodiment, a grid for a battery configured for uniform current collection and transport, comprises a lug, a plurality of vertical grid wires, a top frame grid wire and an electrochemically active material space formed between the vertical grid wires. A lateral cross-section of the vertical grid wires including at least one of an active material utilization enhancer, a primary current collector and transporter, a corrosion resistant coating, a secondary current collection enhancer and transporter and an air core.

In accordance with another embodiment, an electrode for a battery, comprises an active material utilization enhancer at a lateral cross-section of the electrode and the active material utilization enhancer configured in a shape of a Koch fractal curve for maximum perimeter.

In accordance with another embodiment, an electrode for a battery comprises a lateral cross-section of the electrode including at least one of an active material utilization enhancer, a primary current collector and transporter, corrosion resistant coating, a secondary current collection enhancer and transporter and an air core.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a schematic of a grid for a battery, according to an embodiment herein;

FIG. 1b (a) illustrates a schematic of an isometric view of the vertical grid wire, according to an embodiment herein;

FIG. 1b (b) illustrates a schematic of a front view of the vertical grid wire, according to an embodiment herein;

FIG. 2(a) illustrates a schematic of an active material, according to an embodiment herein;

FIG. 2(b) illustrates a schematic of a grid for a battery, according to an embodiment herein;

FIG. 3(a) illustrates a schematic of an active material, according to another embodiment herein;

FIG. 3(b) illustrates a schematic of a grid for a battery, according to another embodiment herein;

FIG. 4 illustrates a schematic of a grid having planar spinal configuration, according to an embodiment herein;

FIG. 5 illustrates a schematic of a grid having planar spinal configuration, according to another embodiment herein;

FIG. 6a illustrates a schematic of a lateral cross-section A of a grid wire, according to an embodiment herein;

FIG. 6b illustrates a schematic of a cross-sectional view of the grid wire/electrode, according to another embodiment herein;

FIG. 6c illustrates a schematic of a cross-sectional view of the primary current collector and transporter and the secondary current collector and transporter, according to an embodiment herein;

FIG. 7a illustrates a schematic of a lateral cross-section of a grid wire, according to another embodiment herein;

FIG. 7b illustrates a schematic of a plurality of lateral cross-sections of a grid wire, according to plurality of embodiments herein;

FIG. 8a illustrates primary current collector and transporters, according to a plurality of embodiments herein;

FIG. 8b illustrates primary current collector and transporter with a secondary current collector and transporter, according to a plurality of embodiments herein;

FIG. 8c illustrates primary current collector and transporter with a secondary current collector and transporter and an air core, according to a plurality of embodiments herein;

FIG. 9 illustrates a grid for a battery, according to another embodiment herein;

FIG. 10a illustrates computational analysis results on a prior art grid having a mid lug;

FIG. 10b illustrates computational analysis results on the grid (FIG. 4) with planar spinal configuration having a mid lug;

FIG. 11a illustrates computational analysis results on a prior art grid having a side lug;

FIG. 11b illustrates computational analysis results on the grid (FIG. 5) with planar spinal configuration having a side lug;

FIG. 12a illustrates lateral cross-section of the grid wire according to a plurality of embodiments herein;

FIG. 12b illustrates computation analysis of the prior art grid;

FIG. 12c illustrates computation analysis of the grid with AMUE;

FIG. 12d illustrates computation analysis of grid with AMUE and SCCET;

FIG. 12e illustrates computation analysis of the grid with AMUE and AC; and

FIG. 12f illustrates computation analysis of the grid with AMUE, SCCET and AC.

### LIST OF NUMERALS

101, 201, 301, 401, 501, 901—Lug
102, 406, 506, 902—Vertical grid wire/electrodes
104, 404, 504—Horizontal grid wire
106a, 410a, 510a, 904—Top frame grid wire
106b, 410b, 510b—Bottom frame grid wire
106c, 410c, 510c—Left frame grid wire
106d, 410d, 510d—Right frame grid wire
108, 408, 508—Active material current collector (AM CC)
110, 202, 302—Top left active material current collector (CCTL)
112, 204, 304—Bottom left active material current collector (CCBL)
114, 206, 306—Top right active material current collector (CCTR)
116, 208, 308—Bottom right active material current collector (CCBR)
118—Top current transporter
120—Bottom current transporter
122—Grid depth
h, h1, h2—Height of grid
w, w1, w2—Width of grid
402, 502—Spine
601—Active material utilization enhancer (AMUE)
603—Primary current collector and transporter (PCCT)
605—Corrosion resistant coating (CRC)
607—Secondary current collector enhancer and transporter (SCCET)
609—Air core (ACWR)

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

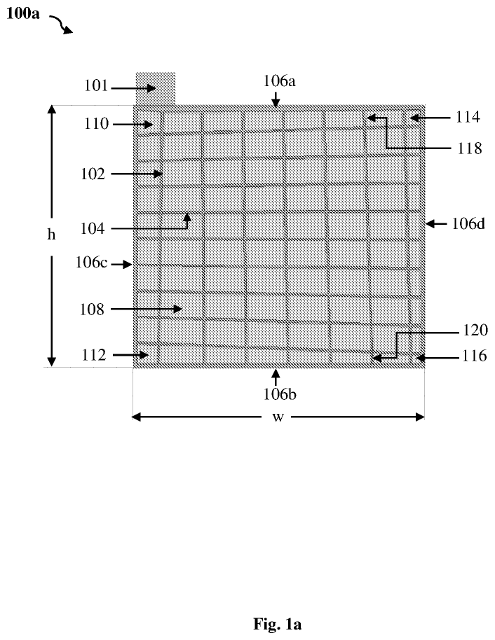

As mentioned above, there is a need for an improved grid and an electrode with reduced weight providing uniform current transport, maximum active material utilization, low ohmic resistance, for improved capacity, specific Energy density, high-rate discharge performance and service life of lead acid battery. In particular, there is a need for an improved grid and electrode thereof for efficient on-demand energy storage of Lead acid batteries. The embodiments herein achieve this by providing “An improved battery grid and electrode thereof”. Referring now to the drawings, and more particularly to FIG. 1a through FIG. 12f, where similar reference characters denote corresponding features consistently throughout the figures, there are shown preferred embodiments.

FIG. 1a illustrates a schematic of a grid for a battery, according to an embodiment. The grid 100 includes a lug 101, a plurality of vertical grid wires/electrodes 102, a plurality of horizontal grid wires 104, frame grid wires 106a, 106b, 106c, 106d, active material current collector 108, a top left active material current collector 110, a bottom left active material current collector 112, a top right active material current collector 114 and a bottom right active material current collector 116.

In an embodiment, the grid 100 includes a planar spatial configuration. The planar spatial configuration of the active material current collectors 108, 110, 112, 114, 116 is configured for optimizing current collection and current transport to the lug 101. A size of the active material current collector is optimized corresponding to width, height, lug position, frame grid wires, and the vertical and horizontal grid wires for maximum and uniform current collection and transport. In an embodiment, planar spatial configuration of the grid reduces internal resistance of the grid for better high-rate discharge performance, enables uniform current in the grid, thereby reducing corrosion of the grid and improving cycle life of the battery.

In an embodiment, the vertical grid wires 102 are arranged vertically across the grid and the horizontal grid wires 104 are arranged horizontally across the grid based on the planar spatial configuration. The vertical grid wires 102 and the horizontal grid wires are placed between the frame grid wires 106a, 106b, 106c, 106d. The vertical grid wires 102 and the horizontal grid wires are current transporters. In an embodiment, the electrochemically active material space (108) is formed between the vertical grid wires (104) and the horizontal grid wires (102). The vertical grid wires 104 include a top current transporter 118 near a top frame grid wire 106a and a bottom current transporter 120 near a bottom frame grid wire 106b.

In an embodiment, the grid 100 includes a height ‘h’ and a width ‘w’. The height ‘h’ is in a range from 10 mm to 1000 mm, preferably 25 mm to 250 mm. The width ‘w’ is in a range from 10 mm to 1000 mm, preferable 40 m to 400 m. The height ‘h’ of the grid is lesser than the width ‘w’ of the grid 100. The planar spatial configuration of the grid includes size of the active material current collector near to the lug 101 greater than the size of the active material current collector near to the lug 101 maximizing uniform current collection and transportation. In an embodiment, the grid 100a is configured wherein size of the top left current collector 110 is greater than the size of the bottom left current collector 112, is greater than size of the top right current collector 114 is greater than the size of the bottom right current collector 116 (Sizes: CCTL>CCBL>CCTR>CCBR). Size of plurality of internal active material current collectors, other than the top left active material current collector 110, the bottom left active material current collector 112, the top right active material current collector 114 and the bottom right active material current collector 116, is a linear variation of the size from the top left active material current collector 110 to the bottom right active material current collector 116.

In an embodiment, dimensions of the grid 100 including but not limited to height ‘h’ of 144 mm and width ‘w’ of 160 mm.

FIG. 1b (a) illustrates a schematic of an isometric view of the vertical grid wire of the grid 100 and FIG. 1b (b) illustrates a schematic of a front view of the vertical grid, according to an embodiment. The vertical grid wire 102 includes the top current transporter 118 and the bottom current transporter 120. The vertical grid wire includes a grid depth 122. In an embodiment, size of the top current transporter 118 is greater than size of the bottom current transporter 120.

FIG. 1c illustrates a schematic of a front view of the horizontal grid wire 104 of the grid 100, according to an embodiment.

In an embodiment, the battery includes but not limited to lead acid battery, bipolar lead acid battery, primary disposable batteries, zinc carbon battery, zinc chloride battery, lithium battery, silver battery, mercury oxide and zinc air battery, secondary rechargeable batteries, nickel cadmium battery, nickel metal hydride battery, alkaline battery, lithium ion battery, lithium ion polymer battery and batteries used in residential, industrial, transportation, consumer, electronic, medical, military and space applications.

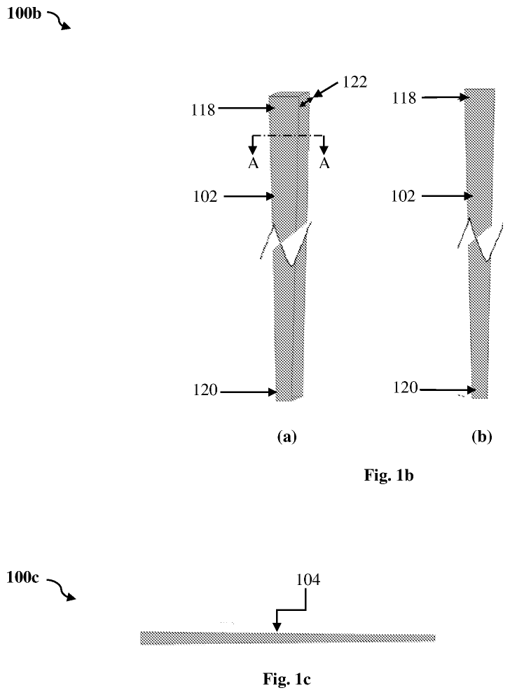

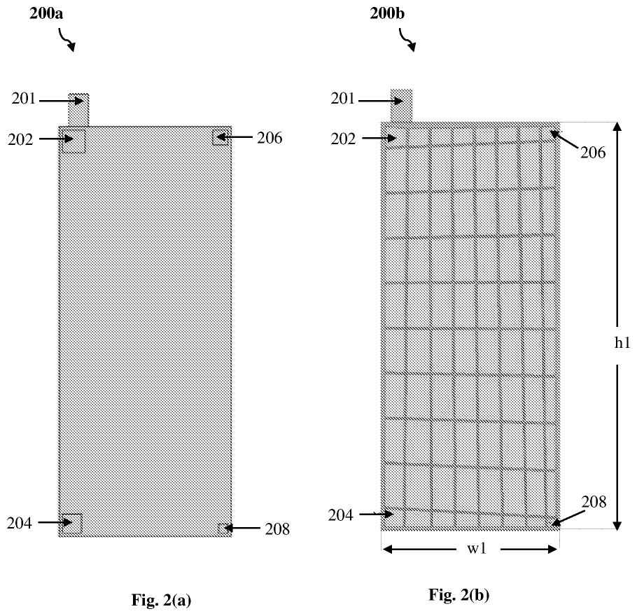

FIG. 2(a) illustrates a schematic of an active material and FIG. 2(b) illustrates a schematic of a grid for a battery, according to another embodiment. Active material current collector 200a and the grid 200b include a planar spatial configuration, wherein height ‘h1’ is greater than width ‘w1’. A top left active material current collector 202, a bottom left active material current collector 204, a top right active material current collector 206 and a bottom right active material current collector 208 are provided as corner current collectors.

The planar spatial configuration includes sizes of the corner active material current collectors nearer to the lug 201 greater than sizes of the corner active material current collectors away from the lug 201. The top left active material current collector 202 and the top right active material current collector 206 are nearer to the lug 201 compared to the bottom left active material current collector 204 and the bottom right active material current collector 208, which are away from the lug. The grid 200b is configured for is configured for maximizing uniform current collection and transportation wherein size of the top left active material current collector 202 is greater than size of the top right active material current collector 206 is greater than size of bottom left active material current collector 204 is greater than size of the bottom right active material current collector 208 (Sizes: CCTL>CCTR>CCBL>CCBR). Size of internal active material current collectors other than the corner active material current collectors, are a linear variation of the sizes from the top left current collector 202 to the bottom right current collector 208.

In an embodiment, dimensions of the grid 200b, includes the height ‘h1’ of 250 mm and the width ‘w1’ of 105 mm.

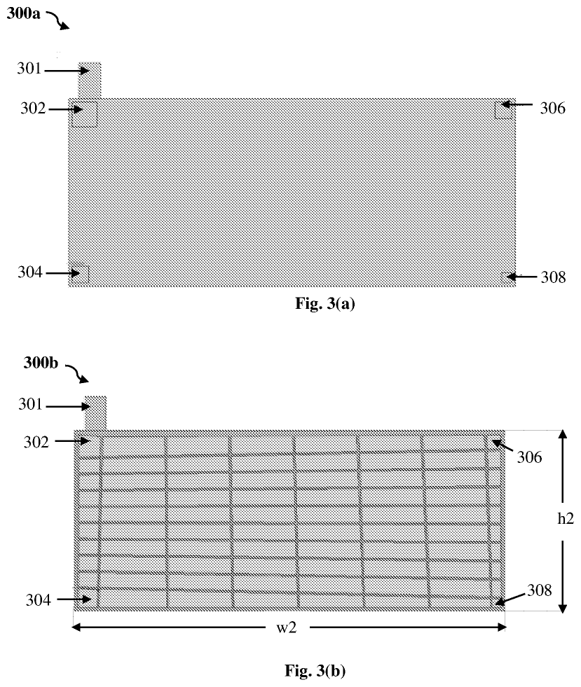

FIG. 3(a) illustrates a schematic of an active material and FIG. 3(b) illustrates a schematic of a grid for a battery, according to another embodiment. Active material current collector 300a and the grid 300b include a planar spatial configuration wherein height ‘h2’ is lesser than width ‘w2’. A top left active material current collector 302, a bottom left active material current collector 304, a top right active material current collector 306 and a bottom right active material current collector 308 are provided as corner current collectors.

The planar spatial configuration includes sizes of the corner active material current collectors nearer to the lug 301 greater than sizes of the corner active material current collectors away from the lug 301. The top left active material current collector 302 and the bottom left active material current collector 304 are nearer to the lug 201 compared to the top right active material current collector 306 and the bottom right active material current collector 308, which are away from the lug. The grid 300b is configured for maximizing uniform current collection and transportation wherein size of the top left active material current collector 302 is greater than size of bottom left active material current collector 304 is greater than size of the top right active material current collector 306 is greater than size of the bottom right active material current collector 308 (Sizes: CCTL>CCBL>CCTR>CCBR). Size of internal active material current collectors other than the corner active material current collectors, are a linear variation of the sizes from the top left current collector 302 to the bottom right current collector 308.

In an embodiment, dimensions of the grid 300b, includes the height ‘h2’ of 105 mm and the width ‘w2’ of 250 mm.

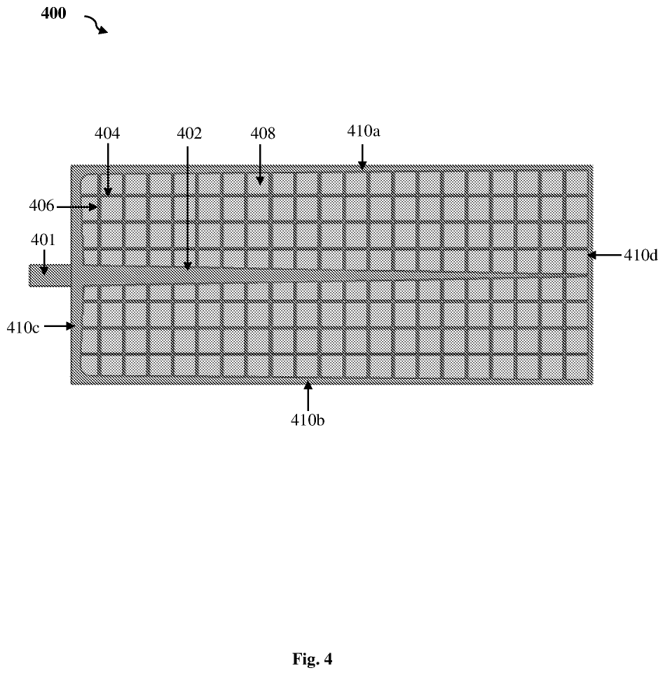

FIG. 4 illustrates a schematic of a grid having planar spinal configuration, according to an embodiment. The grid 400 is configured to a planar spinal configuration. In an embodiment, the grid 400 includes a lug 401, a spine 402, a plurality of horizontal grid wires 404, a plurality of vertical grid wires 406, an active material 408 and frame grid wires 410a, 410b, 410c, 410d. In the planar spinal configuration, the spine 402 is provided at a location corresponding to a location of the lug (401). The grid 400 is configured wherein size of the spine 402 is greater than size of the frame grid wires 410a, 410b, 410c, 410d; and size of the spine 402 is lesser than the size of the horizontal grid wires 404 and the vertical grid wires 406.

In an embodiment, the lug 401 is placed middle on the frame grid wire 410c.

The planar spinal configuration allows faster current flow by creating low resistance path from the active material current collectors 408 to the lug 401. The planar spinal configuration produces lower ohmic drop of the grid thereby improving high-rate discharge performance.

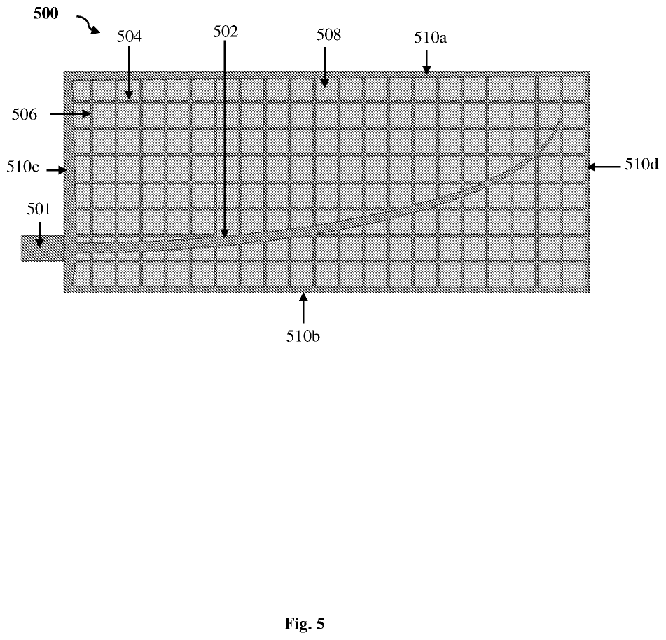

FIG. 5 illustrates a schematic of a grid having planar spinal configuration, according to another embodiment. The grid 500 is configured to a planar spinal configuration. In an embodiment, the grid 500 includes a lug 501, a spine 502, a plurality of horizontal grid wires 504, a plurality of vertical grid wires 506, an active material 508 and frame grid wires 510a, 510b, 510c, 510d. In the planar spinal configuration, the grid 500 is configured wherein size of the spine 502 is greater than size of the frame grid wires 510a, 510b, 510c, 510d; and size of the spine 502 is lesser than the size of the horizontal grid wires 504 and the vertical grid wires 506.

In an embodiment, the lug 501 is placed at a side on the frame grid wire 510c.

In an embodiment, a method of manufacturing the grid (100a, 200b, 300b, 400, 500) includes casting, stamping, extrusion, injection molding, compression molding, plating. For continuous manufacturing by co-casting, co-stamping, co-extrusion, co-injection molding, co-compression molding and co-plating grid wire constituents for battery manufacturing method is enabled.

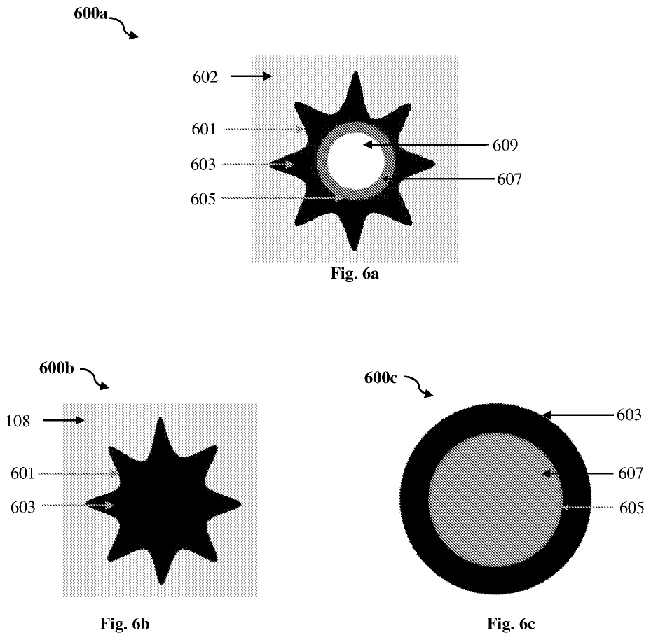

FIG. 6a illustrates a schematic of a lateral cross-section A of the vertical grid wire 102, according to an embodiment. 600a shows the lateral cross-section of the grid wire (current transport) and the active material current collector. In an embodiment, the grid wires 102, 104 are designed for uniform current collection, uniform current transport, maximum active material utilization, low ohmic resistance, and reduced weight. The lateral cross-section 600a is configured for including an active material 602, an active material utilization enhancer 601, a primary current collector and transporter 603, a corrosion resistance coating 605, a secondary current collection and transporter 607, and an air core 609.

In an embodiment, the active material utilization enhancer 601 is an interface between the current transporter (grid wires) and the current collector. A design of the active material utilization enhancer 601 maximizes battery capacity, improves uniform current density, decreases corrosion and increases service life. The design of the active material utilization enhancer 601 maximizes surface perimeter for a given area of active material current collector 108. Maximizing the surface perimeter increases interface and interaction between the active material current collector 108 and the grid wire 102. The interface maximizes the utilization of active material 108 for a given volume, thereby maximizing capacity of the battery. Increased capacity of the battery improves uniform current density in the electrode grid, thereby minimizing corrosion of the grid. Decreased corrosion of the grid increase service life of the battery.

In an embodiment, the active material utilization enhancer 601 shaped as a fractal curve for maximum perimeter, preferably Koch fractal curve. Table B compares values of perimeters for shapes of circle, square and Koch fractal Curve with N iterations for a given area of 10 units.

TABLE B

| Shape/Curve | Dia/side/N | Area | Perimeter |
|---|---|---|---|
| Circle | 3.57 | 10 | 11 |
| Square | 3.16 | 10 | 13 |
| Koch curve N | 4 | 10 | 36 |
| Koch curve N | 8 | 10 | 114 |
| Koch curve N | 16 | 10 | 1137 |
| Koch curve N | 32 | 10 | 113487 |
| Koch curve N | 64 | 10 | 1129754277 |

As shown in the Table B, the Koch curve provides maximum perimeter for the same area of 10 units.

In an embodiment, the primary current collector and transporter 603 is provided for current collection and current transport. Material of the primary current collector and transporter 603 including but not limited to lead and lead alloys.

In an embodiment, the corrosion resistance coating 605 provided for preventing formation of corrosion on the grid wires. Material of the corrosion resistance coating 605 including but not limited to Polyaniline, conductive composites. The material exhibiting good electrical conducting property and corrosion resistance.

In an embodiment, the secondary current collector enhancer and transporter 607 is provided for current collection and current transport. Material of the secondary current collector and transporter 603 including but not limited to copper, aluminum, carbon/graphite fiber. The material including good electrical conducting property, being light in weight and specific conductivity higher than lead/lead alloys.

Table A, shows a list of plurality of materials and their specific conductivity (Electrical conductivity (S/m) divided by density (kg/m3)).

TABLE A

| | | | | Specific |
|---|---|---|---|---|
| | Resistivity | Conductivity | Density | conductivity |
| Material | (Ω · m) | (S/m) | (kg/m3) | (S/m)/(Kg/m3) |
| Lithium | 9.28 × 10⁻⁸ | 1.08E+07 | 535 | 20,187 |
| Aluminum | 2.82 × 10⁻⁸ | 3.50E+07 | 2700 | 12,963 |
| Copper | 1.68 × 10⁻⁸ | 5.98E+07 | 8940 | 6,689 |
| Silver | 1.59 × 10⁻⁸ | 6.30E+07 | 10500 | 6,000 |
| Carbon (graphite) | 2.5 × 10⁻⁶ | 2.00E+06 | 1600 | 1,250 |
| Zinc | 5.90 × 10⁻⁸ | 1.69E+07 | 7133 | 2,369 |
| Nickel | 6.99 × 10⁻⁸ | 1.43E+07 | 8908 | 1,605 |
| Iron | 1.0 × 10⁻⁷ | 1.00E+07 | 7870 | 1,271 |
| Tungsten | 5.60 × 10⁻⁸ | 1.79E+07 | 19250 | 930 |
| Lead | 2.2 × 10⁻⁷ | 4.55E+06 | 11300 | 403 |
| Stainless steel | 6.9 × 10⁻⁷ | 1.45E+06 | 7800 | 186 |
| Air | 1.3 to 3.3 × 10⁻¹⁶ | 3.00E−15 | 1.225 | 0 |

In an embodiment, the air core 609 is provided at a center of the grid wire for reducing weight of the grid wires thereby improving battery specific energy density.

The secondary current collector enhancer and transporter 607 is provided surrounding the air core 609. The air core 609 absorbs thermal stress induced due to charging, discharging cycle, and operation loads and improves structural and thermal performance of the grid.

In an embodiment, the lateral cross-section of the grid wire/electrode included a combination consisting at least one of the primary current collector and transporter 603, the corrosion resistance coating 605, the secondary current collector enhancer and transporter 607, and the air core 609.

FIG. 6b illustrates a schematic of a cross-sectional view of an electrode/grid wire including the active material utilization enhancer, according to another embodiment. The lateral cross-section of the electrode including an active material utilization enhancer 601 designed in a shape for maximizing perimeter and increasing interface between the active material current collector 108 and the grid wire. In an embodiment, active material utilization enhancer 601 shaped in a fractal curve for maximum surface perimeter, thereby thereby maximizing battery capacity, improving uniform current density, decreasing corrosion and increasing service life. In an embodiment, the fractal curve is a Koch fractal curve.

FIG. 6c illustrates a schematic of a cross-sectional view of the primary current collector and transporter and the secondary current collector and transporter. The secondary current collector and transporter 607 is provided at an inner area of the cross-section, the corrosion resistance coating 605 is provided surrounding the secondary current collector and transporter 607. The primary current collector and transporter 603 is provided at an outer portion surrounding the corrosion resistance coating 605.

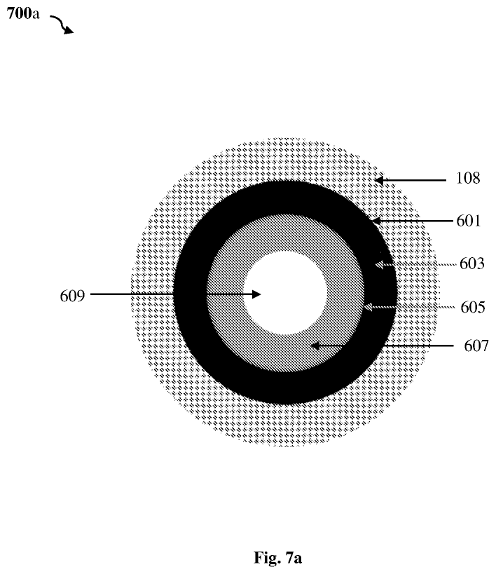

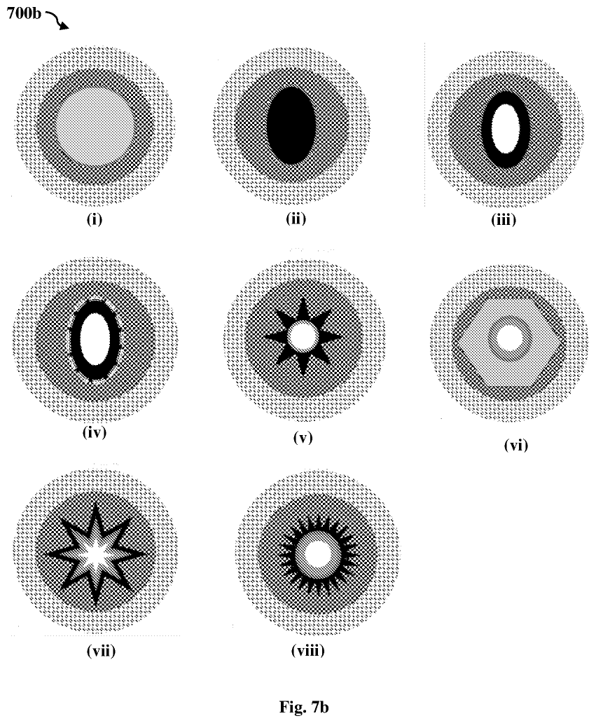

FIG. 7a illustrates a schematic of a lateral cross-section of a grid wire, according to another embodiment. 700a provides another design of the active material utilization enhancer 601 for maximizing surface perimeter for a given area of the active material 108.

FIG. 7b illustrates a schematic of a plurality of lateral cross-sections of a grid wire, according to plurality of embodiments. The plurality of embodiments (i), (ii), (iii), (iv), (v), (vi), (vii), (viii) includes a plurality of shapes and areas of the active material utilization enhancer 601, the primary current collector and transporter 603, the corrosion resistance coating 605, the secondary current collector and transporter 607, and the air core 609 for improving battery capacity, uniform current density, service life, structural and thermal performance and reducing corrosion and weight.

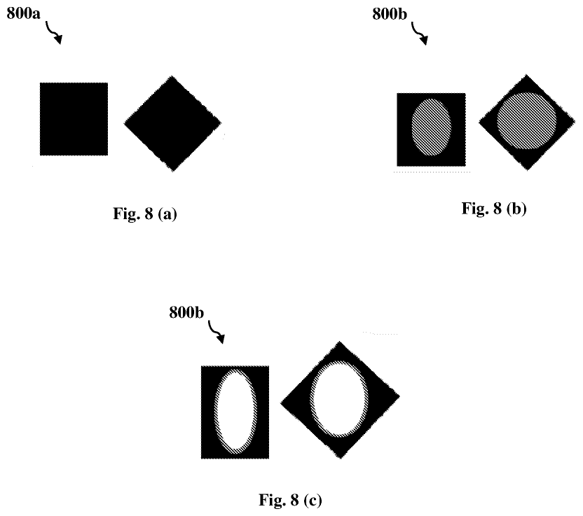

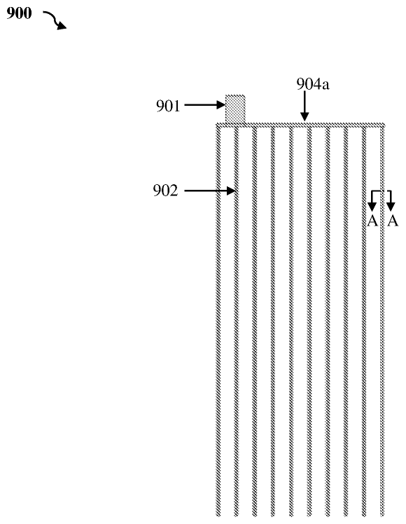

FIG. 8a illustrates primary current collector and transporters, according to a plurality of embodiments. In an embodiment, material of the primary current collector and transporters includes but not limited to lead, lead sulphate and lead alloys.

FIG. 8b illustrates primary current collector and transporter with a secondary current collector and transporter, according to a plurality of embodiments. In an embodiment, material of the secondary current collector and transporters includes but not limited to copper, aluminium, carbon/graphene fiber and any solid metal. In an embodiment, material of the secondary current collector and transporters includes material with specific conductivity higher than lead/lead alloys.

FIG. 8c illustrates primary current collector and transporter with a secondary current collector and transporter and an air core, according to a plurality of embodiments. A size and shape of the air core is changed based on weight reduction required for the battery. In an embodiment, corrosion resistance coating is provided around the air core.

TABLE 1.1

| | | Total electrode grid | Weight |
|---|---|---|---|
| FIG. No. | Grid constituents | weight (kg) | reduction (%) |
| FIG. 8 (a) | PCCT (Pb/PbSO4) | 0.175 | 0% |
| FIG. 8 (b) | PCCT (Pb/PbSO4) and | 0.074 | 58% |
| | SCCT (Cu) | | |
| FIG. 8 (b) | PCCT (Pb/PbSO4) and | 0.107 | 39% |
| | SCCT (Al) | | |
| FIG. 8 (b) | PCCT (Pb/PbSO4) and | 0.099 | 44% |
| | SCCT (Carbon fibre) | | |

Table 1.1 shows computational experiment results corresponding to weight reduction of the primary current collector and transporter (PCCT) of FIG. 8a and primary current collector and transporter (PCCT) with a secondary current collector and transporter (SCCT) of FIG. 8b.

The results shows that primary current collector and transporter of lead/lead sulphate with the secondary current collector and transporter of copper provides maximum weight reduction of 58% with grid weight of 0.074 kg compared to a standard primary current collector and transporter of lead/lead sulphate without SCCT having a grid weight of 0.175 kg.

TABLE 1.2

| | | Total electrode | Weight |
|---|---|---|---|
| FIG. No. | Grid constituents | grid weight (kg) | reduction (%) |
| FIG. 8 (a) | PCCT (Pb/PbSO4) | 0.175 | 0% |
| FIG. 8 (c) | PCCT (Pb/PbSO4) with | 0.085 | 52% |
| | SCCT (Cu) and Air Core | | |
| FIG. 8 (c) | PCCT (Pb/PbSO4) with | 0.111 | 36% |
| | SCCT (Al) and Air Core | | |
| FIG. 8 (c) | PCCT (Pb/PbSO4) with | 0.090 | 49% |
| | SCCT (Carbon fibre) and Air | | |
| | Core | | |

Table 1.2 shows computational experiment results corresponding to weight reduction of the primary current collector and transporter (PCCT) of FIG. 8a and primary current collector and transporter (PCCT) with a secondary current collector and transporter (SCCT) and air core of FIG. 8c.

The results shows that primary current collector and transporter of lead/lead sulphate with the secondary current collector and transporter of Copper and the air core together provides maximum weight reduction of 52% with grid weight of 0.085 kg compared to a standard primary current collector and transporter of material lead/lead sulphate without SCCT and the air core having a grid weight of 0.175 kg.

Operation of the battery provided with the grid is as follows. Lead-acid batteries are composed of a Lead-dioxide cathode, a sponge metallic Lead anode and a Sulphuric acid solution electrolyte. Electrical energy is stored as chemical energy and this chemical energy is converted to electrical energy as and when required.

The conversion of electrical energy into chemical energy by applying external electrical source is known as charging of battery. Whereas conversion of chemical energy into electrical energy for supplying external load is known as discharging of secondary battery.

Battery grid is the precursor for active material and current distribution in lead acid electrochemical cell. Configuration of the grid is critical for minimizing ohmic drop, uniform current distribution and for more reaction sites. The positive grid was used for multi physics optimization with the electrode, electrolyte and porous electrode. The volume fraction/weight fraction of the electrode, current density, electrode potential and total power dissipation density are monitored for performance comparison. The current density is correlated to corrosion resistance and long life cycle time. The electrolyte potential or ohmic drop are correlated to high-rate discharge performance and overall battery performance. The weight of the grid is correlated to weight of the battery and to overall specific energy (kwh/kg) of the battery.

Computational Electromagnetic (CEM) and electrochemistry experimental simulation are performed for multi physics optimization of lead acid battery and for evaluation of efficiency and performance improvement according to the embodiments of the present disclosure.

For the battery performance evaluation, a symmetrical segment of the positive electrode grid, active material and electrolyte is used. The governing transport mechanism for the electrochemistry of lead-acid battery is due to migration, diffusion and convection molar flux of charged species (j). For the grid design, the Laplace equation is used to model ionic transport performance. Appropriate Electrode equilibrium potential is used. The governing equation for the battery performance is given below.

$${N}_{j} = {z}_{j} {μ}_{j} {FC}_{j} ▽ ∅ - {D}_{j} ▽ {C}_{j} + {C}_{j} v$$

$${▽}_{i} = {σ▽}^{2} ∅$$

$${▽}^{2} ∅ = 0$$

$$η = E - {E}_{e} - ∅$$

Where Nj is iconic flow, Zj is charge, Dj is the diffusion coefficient. μj is ionic electrochemical mobility, F is the Faraday's constant, Cj is concentration, Ø is electrostatic potential outside the electric double layer.

A discharge current of 100 A is applied to an end of the lug. The primary current condition, relating the electrolyte and electrode potentials is set to the equilibrium potential of 1.7 V. The potential in the electrolyte is set to zero at the external boundary that is parallel to the grid.

Total electrode current density, Normal electrode current density, and total power dissipation density, electric potential, electrolyte potential are monitored for performance evaluations.

The area/volume fraction/weight fraction of the standard and new battery grid is maintained at the same area/volume fraction/weight fraction for comparison.

FIG. 9 illustrates a grid for a battery, according to another embodiment herein. The grid 900 includes a lug 901, a plurality of vertical grid wires 902, a top frame grid wire 904a, active material current collector 906. The electrochemically active material space (906) is formed between the vertical grid wires (902).

In an embodiment, a lateral cross-section A of the vertical grid wire 902 includes a combination including at least one of the active material utilization enhancer 601, primary current collector and transporter 603, the corrosion resistance coating 605, the secondary current collector enhancer and transporter 607, and the air core 609.

In an embodiment, the active material utilization enhancer 601 configured in a shape of a fractal curve with maximum perimeter. In an embodiment, the fractal curve is a Van Koch fractal curve.

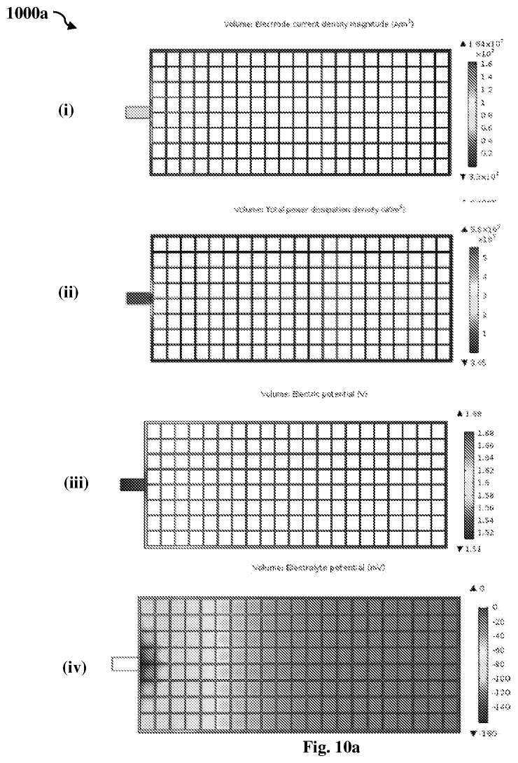

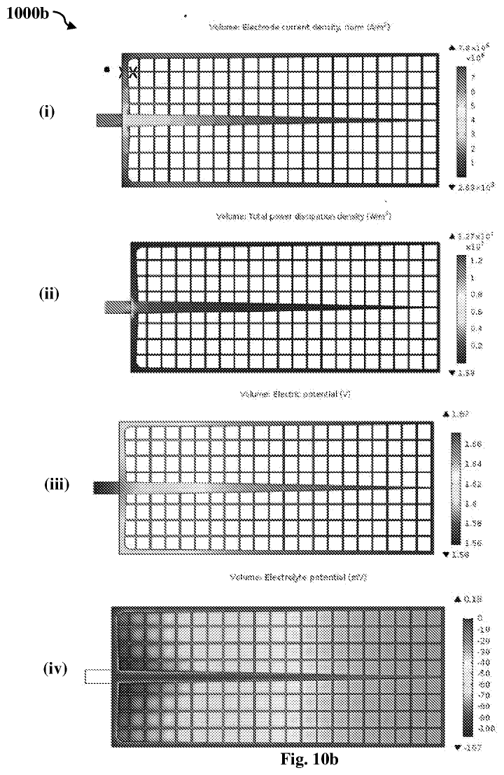

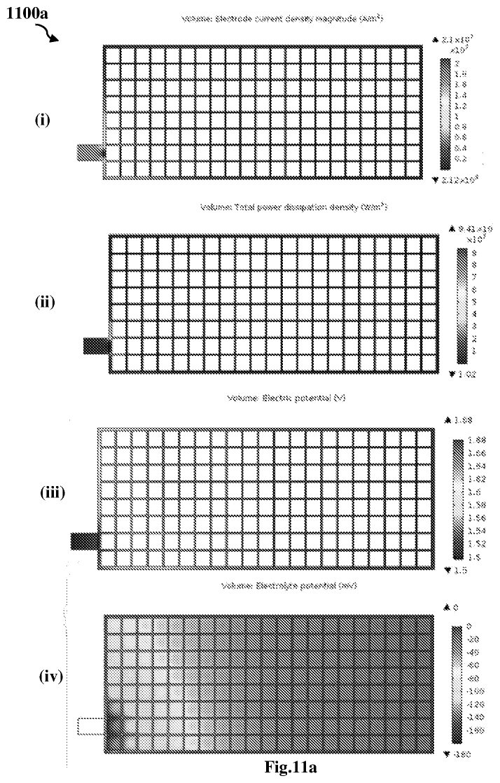

FIG. 10a illustrates computational analysis results on a prior art grid having a mid lug, and FIG. 10b illustrates computational analysis results on the grid (FIG. 4) with planar spinal configuration having a mid lug.

FIGS. 10a (i) and 10b (i) show computational analysis results of Electrode Current Density (A/m²), FIGS. 10a (ii) and 10b (ii) show computational analysis results of Total Power Dissipation Density (W/m³), FIGS. 10a (iii) and 10b (iii) show computational analysis results of Electric potential (V) and FIGS. 10a (iv) and 10b (iv) show computational analysis results of Electrolyte Potential (mV) on the prior art grid having a mid lug without a planar spinal configuration the grid (FIG. 4) with planar spinal configuration having a mid lug.

Table 2.1 shows the values of results obtained from the computational analysis corresponding to Electrode Current Density (A/m2), Total Power Dissipation Density (W/m3), Electric potential (V) and Electrolyte Potential (mV)/ohmic drop and the percentage of improvement (%) compared to prior art.

TABLE 2.1

| | | | | | | | | | | Electrolyte |
|---|---|---|---|---|---|---|---|---|---|---|
| | | | | | | | | | | Potential |
| | Electrode Current Density | | | Total Power dissipation density | | | Electric | | | (mV) |
| | (A/m²) | | | (W/m³) | | | Potential (V) | | | Ohmic |
| S. No | Max | Min | Range | Max | Min | Range | Max | Min | Range | drop |
| Prior. | 1.6400E | 3300 | 1.64E+07 | 5.600E+07 | 3.0500 | 5.600E+07 | 1.68 | 1.51 | 0.17 | 160 |
| FIG. 4 | 7.800E+06 | 2630 | 7.80E+06 | 1.270E+07 | 1.5800 | 1.270E+07 | 1.67 | 1.56 | 0.11 | 107 |
| % | 52% | | 52% | 77% | | | | | 35% | 33% |

Clearly, the grid with the planar spinal configuration (FIG. 4) provides improvement of 52% compared to the prior art in Electrode Current Density, 77% improvement compared to the prior art in Total Power dissipation density, 35% improvement compared to the prior art in Electric Potential and 33% improvement compared to the prior art in Electrolyte potential.

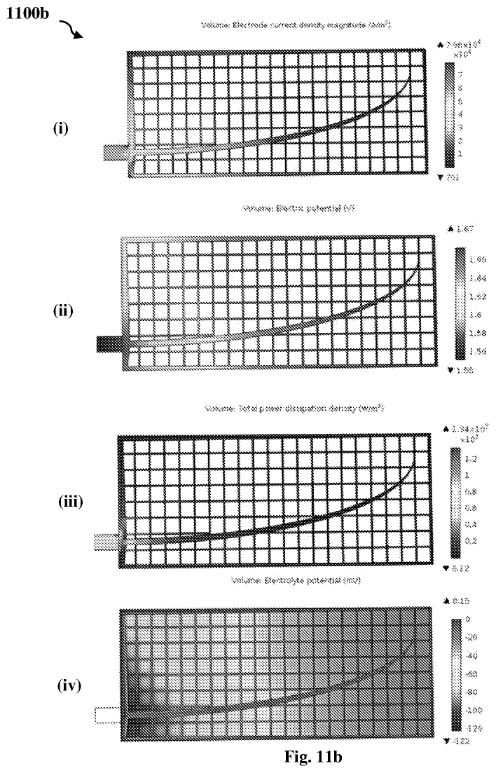

FIG. 11a illustrates computational analysis results on a prior art grid having a side lug, and FIG. 11b illustrates computational analysis results on the grid (FIG. 5) with planar spinal configuration having a side lug.

FIGS. 11a (i) and 11b (i) show computational analysis results of Electrode Current Density (A/m2), FIGS. 11a (ii) and 11b (ii) show computational analysis results of Total Power Dissipation Density (W/m3), FIGS. 11a (iii) and 11b (iii) show computational analysis results of Electric potential (V) and FIGS. 11a (iv) and 11b (iv) show computational analysis results of Electrolyte Potential (mV) on the prior art grid having a side lug without a planar spinal configuration and the grid (FIG. 5) with planar spinal configuration having a side lug.

Table 2.2 shows the values of results obtained from the computational analysis corresponding to Electrode Current Density (A/m2), Total Power Dissipation Density (W/m3), Electric potential (V) and Electrolyte Potential (mV)/ohmic drop and the percentage of improvement (%) compared to the prior art grid.

TABLE 2.2

| | | | | | | | | | | Electrolyte |
|---|---|---|---|---|---|---|---|---|---|---|
| | | | | | | | | | | Potential |
| | Electrode Current Density | | | Total Power dissipation | | | Electric | | | (mV) |
| | (A/m²) | | | density (W/m³) | | | Potential (V) | | | Ohmic |
| S. No | Max | Min | Range | Max | Min | Range | Max | Min | Range | drop |
| Prior. | 2.100E | 2120 | 2.10E+07 | 94100000 | 1.0200 | 94099999 | 1.68 | 1.50 | 0.18 | 180.00 |
| FIG. 5 | 7.980E+06 | 701 | 7.98E+06 | 13400000 | 0.1200 | 13400000 | 1.67 | 1.56 | 0.12 | 122.00 |
| % | 62% | | | 86% | | | | | 53% | 32% |

As shown above, the grid with the planar spinal configuration (FIG. 5) having a side lug provides improvement of 62% compared to the prior art in Electrode Current Density, 86% improvement compared to the prior art in Total Power dissipation density, 53% improvement compared to the prior art in Electric Potential and 32% improvement compared to the prior art in Electrolyte potential.

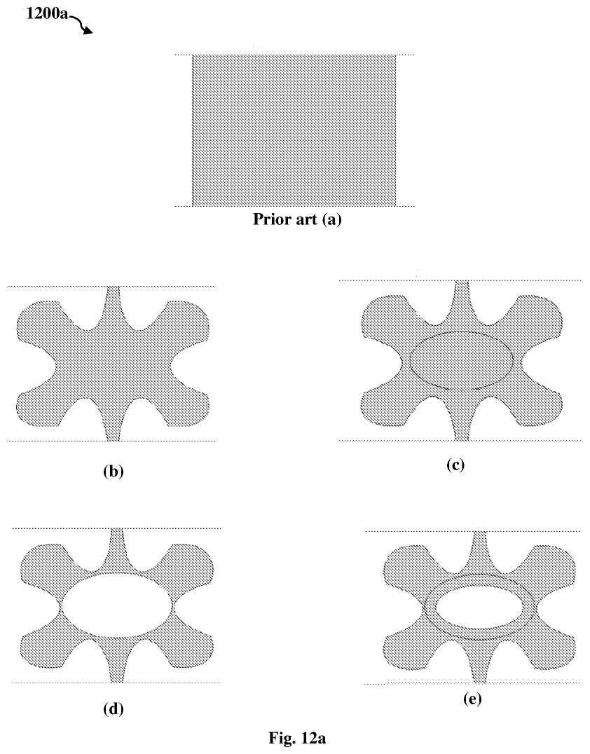

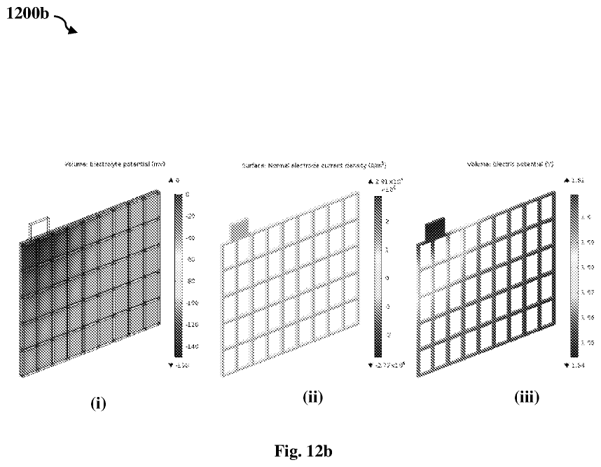

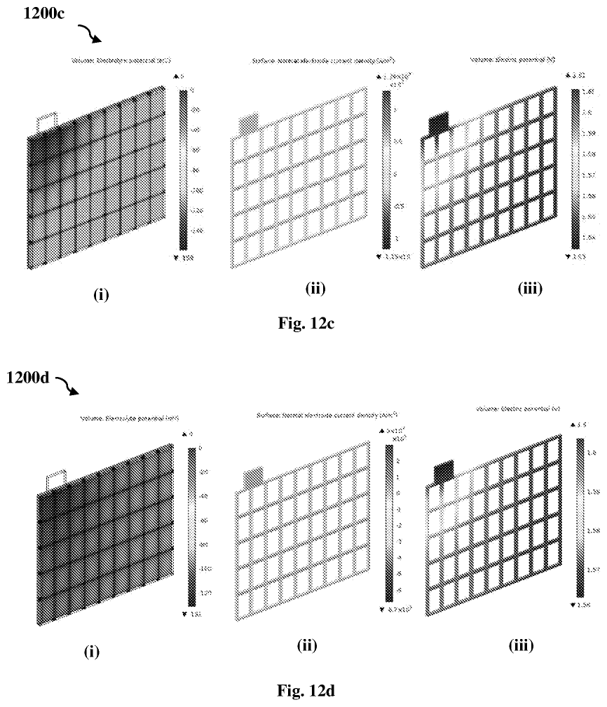

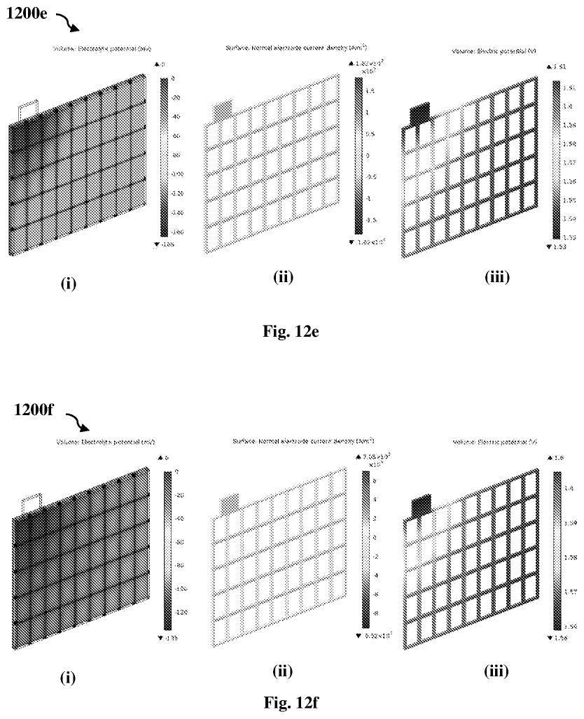

FIG. 12a illustrates lateral cross-section of the grid wire according to a plurality of embodiments. In an embodiment, the FIG. 12a (a) provides a prior art lateral cross-section of the grid wire. FIG. 12a (b) provides a lateral cross-section of the grid wire including active material utilization enhancer (AMUE), according to an embodiment. FIG. 12a (c) provides a lateral cross-section of the grid wire including active material utilization enhancer (AMUE) and a secondary current collector enhancer and transporter (SCCET), according to an embodiment. FIG. 12a (d) provides a lateral cross-section of the grid wire including active material utilization enhancer (AMUE), and an air core (AC). FIG. 12a (e) provides a lateral cross-section of the grid wire including active material utilization enhancer (AMUE), a secondary current collector enhancer and transporter (SCCET), and an air core (AC) according to an embodiment.

Table 3.1 provides the values of Electrode cross-sectional area (m²), Electrode perimeter (m), Improvement in active material utilization (%), Total electrode weight (kg) and Grid weight reduction (%) determined for the FIG. 12a (a) (Prior art), FIG. 12a (b) (AMUE), FIG. 12a (c) (AMUE+SCCET), FIG. 12a (d) (AMUE+AC), and FIG. 12a (e) (AMUE+SCCET+AC).

TABLE 3.1

| | | Electrode | | Improvement | Total | Grid |
|---|---|---|---|---|---|---|
| | | cross- | Electrode | in active | electrode | weight |
| | Electrode Grid | sectional | perimeter | material | weight | reduction |
| Fig | constituents | area (m²) | (m) | utilization (%) | (kg) | (%) |
| (a) | Prior art | 5.60E−06 | 9.600E−03 | 0% | 0.157 | 0.0% |
| (b) | AMUE | 5.62E−06 | 1.546E−02 | 61% | 0.157 | 0.1% |
| (c) | AMUE + SCCET | 5.62E−06 | 1.546E−02 | 61% | 0.151 | −3.4% |
| (d) | AMUE + AC | 3.74E−06 | 2.057E−02 | 114% | 0.129 | −17.5% |
| (e) | AMUE + SCCET + AC | 3.74E−06 | 2.057E−02 | 114% | 0.136 | 13.9% |

Clearly, the lateral cross-section of the grid wire including active material utilization enhancer (AMUE), a secondary current collector enhancer and transporter (SCCET), and an air core (AC) provides 114% improvement in active material utilization compared to the prior art with grid weight reduction of 13.9%.

Computational analysis has been performed on the FIG. 12a (a) (Prior art), FIG. 12a (b) (AMUE), FIG. 12a (c) (AMUE+SCCET), FIG. 12a (d) (AMUE+SCCET+AC) corresponding to Electrode current density magnitude, Electrolyte potential (mV), Reduction in grid resistance (%), Total normal electrode current density (A), Average normal electrode current density (A/m²) and Reduction in grid current density (%).

FIG. 12b illustrates computation analysis of the prior art grid, FIG. 12c illustrates computation analysis of the grid with AMUE, FIG. 12d illustrates computation analysis of grid with AMUE and SCCET, FIG. 12e illustrates computation analysis of the grid with AMUE and AC; and FIG. 12f illustrates computation analysis of the grid with AMUE, SCCET and AC corresponding to (i) Volume: Electrolyte potential (mV), (ii) Surface: Normal electrode current density (A/m²) and (iii) Volume: Electric potential (V).

Table 3.2 provides values of results obtained from the computational analyses performed on the embodiments and prior arts of FIG. 12a.

TABLE 3.2

| | | | | | Total | Average | |
|---|---|---|---|---|---|---|---|
| | | | | | normal | normal | |
| | | Electrode | | Reduction | electrode | electrode | Reduction |
| | | current | Electrolyte | in grid | current | current | in grid |
| | Electrode Grid | density | potential | resistance | density | density | current |
| Fig. | constituents | magnitude | (mV) | (%) | (A) | (A/m²) | density |
| (a) | Prior art | 13.814 | 159.12 | 0.0% | 102.30 | 4357.70 | 0.0% |
| (b) | AMUE | 13.822 | 159.03 | −0.1% | 93.91 | 2789.40 | −36.0% |
| (c) | AMUE + SCCET | 14.353 | 130.84 | −17.8% | 84.97 | 2523.30 | −42.1% |
| (d) | AMUE + AC | 12.302 | 164.56 | 3.4% | 104.28 | 2838.50 | −34.8% |
| (e) | AMUE + SCCET + AC | 14.106 | 134.93 | −15.2% | 100.55 | 2396.70 | −45.0% |

The results show that the grid (c) with active material utilization enhancer (AMUE) and the secondary current collector enhancer and transporter (SCCET), provides maximum reduction in grid resistance of 17.8% compared to the prior art grid. The grid (e) with active material utilization enhancer (AMUE), the secondary current collector enhancer and transporter (SCCET), and the air core (AC) provides reduction in grid current density of 45% compared to the prior art grid.

A main advantage of the present disclosure is that the battery grid improves uniform current collection, uniform current transport and maximizes active material utilization.

Another advantage of the present disclosure is that the battery grid provides low ohmic resistance and offers resistance to corrosion.

Still another advantage of the present disclosure is that the battery grid is light in weight and reduces total weight of the battery.

Yet another advantage of the present disclosure is that the battery grid is durable and multi-material for improved battery capacity.

Still another advantage of the present disclosure is that the battery grid improves specific energy density, provides high-rate discharge performance and maximizes service life of the battery.

Yet another advantage of the present disclosure is that the battery grid provides improved resistance to thermal loads, structural loads and live loads.

Still another advantage of the present disclosure is that the battery grid maximizes chemical, electrical, thermal, structural, service performance of the battery.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1-16. (canceled)

17. A grid for a battery, comprising:
a plurality of vertical grid wires;
a plurality of horizontal grid wires;
a plurality of frame grid wires;
wherein the vertical grid wires and the horizontal grid wires are provided between the frame grid wires for current transport;
an active material current collector provided for current collection;
an active material utilization enhancer configured in a lateral cross-section of the grid wires, with a maximum surface perimeter; and
wherein the lateral cross-section of the grid wires include at least one of a primary current collector and transporter, a corrosion resistant coating, a secondary current collection enhancer and transporter and an air core.

18. The grid as claimed in claim 17, wherein the air core is provided at a center of the lateral cross-section of the grid wire for reducing weight of the grid;
wherein the secondary current collection enhancer and transporter are provided in an axially inner portion of the lateral cross-section;
wherein the corrosion resistant coating surrounds the secondary current collection enhancer and transporter; and
wherein the primary current collector and transporter surround the corrosion resistant coating.

19. The grid as claimed in claim 17, wherein a material of the primary current collector and transporter include lead and lead alloys.

20. The grid as claimed in claim 17, wherein a material of the corrosion resistant coating of conductive composites and materials exhibit electrical conducting property and corrosion resistance.

21. The grid as claimed in claim 17, wherein a material of the secondary current collection enhancer and transporter include a material with a specific conductivity higher than lead and lead alloys.

22. The grid as claimed in claim 17, wherein the grid includes a planar spatial configuration, wherein sizes of first corner active material current collectors nearer to a lug are greater than sizes of second corner active material current collectors away from the lug for maximizing uniform current collection and transport.

23. The grid as claimed in claim 22, wherein sizes of third active material current collectors other than the first and second active material current collectors are in linear spatial progression from the first corner active material current collectors nearer to the lug to the second corner active material current collectors away from the lug.

24. The grid as claimed in claim 17, wherein the grid including a planar spinal configuration includes a spine provided at a location corresponding to a location of a lug; and
wherein a size of the spine is greater than a size of frame grid wires and lesser than a size of the horizontal grid wires and the vertical grid wires for allowing faster current flow.

25. The grid as claimed in claim 17, wherein the vertical grid wires include a top current collector nearer to the top frame grid wire and a bottom current collector nearer to the bottom frame grid wire; and
wherein a size of the top current collector is greater than a size of the bottom current collector.

26. The grid as claimed in claim 17, wherein the active material utilization enhancer is configured in a shape of a Koch fractal curve with a maximum surface perimeter for a given area of the active material current collector, thereby maximizing battery capacity, improving uniform current density, decreasing corrosion, and increasing service life.

27. The grid as claimed in claim 17, wherein the battery is selected from the group consisting of lead acid battery, bipolar lead acid battery, primary disposable batteries, zinc carbon battery, zinc chloride battery, lithium battery, silver battery, mercury oxide and zinc air battery, secondary rechargeable batteries, nickel cadmium battery, nickel metal hydride battery, alkaline battery, lithium ion battery, lithium ion polymer battery and batteries and combinations thereof, wherein the battery is operable to be used in residential, industrial, transportation, consumer, electrical, electronic, medical, military, telecommunication and space applications.

28. A grid for a battery configured for uniform current collection and transport, comprising:
an electrochemically active material space formed between vertical grid wires and horizontal grid wires;
wherein sizes of first corner active material current collectors nearer to a lug are greater than sizes of second corner active material current collectors away from the lug; and
wherein a size of third active material current collectors other than the first and second active material current collectors are in a linear spatial progression from the third corner active material current collectors nearer to the lug to the first and second corner active material current collectors away from the lug.

29. A grid for a battery configured for uniform current collection and transport, comprising:
a lug;
a plurality of vertical grid wires;
a top frame grid wire;
an electrochemically active material space formed between the vertical grid wires; and
a lateral cross-section of the vertical grid wires including at least one of an active material utilization enhancer, a primary current collector and transporter, a corrosion resistant coating, a secondary current collection enhancer and transporter and an air corc.
